(19) United States
(12) Patent Application Publication
(10) Pub. No.: US 2008/0023489 A1
(43) Pub. Date: Jan. 31, 2008

(54) Remote metering station and applicator heads interconnected by means of relatively short hoses with universal connectors

(75) Inventor: Mel Steven Lessley, Villa Hills, KY (US)

Correspondence Address: Steven W. Weinrieb;SCHWARTZ & WEINRIEB, Crystal Plaza One, Suite 1109, 2001 Jefferson Davis Highway, Arlington, VA, 22202, US

(73) Assignee: ILLINOIS TOOL WORKS INC.

(21) Appl. No.: 11/495,691

(22) Filed: Jul. 31, 2006

(51) Int. Cl. B67D 5/62

(52) U.S. Cl. 222/146.5

(57) ABSTRACT

A hot melt adhesive dispensing system comprises a remote metering station for receiving a supply of hot melt adhesive material from an adhesive supply unit (ASU), a plurality of applicator heads for depositing hot melt adhesive material onto different substrates, and a plurality of relatively short hose structures respectively fluidically inter-connecting the remote metering station to the plurality of applicator heads. Oppositely disposed terminal end portions of each one of the relatively short hose structures are respectively provided with universal connectors so as to effectively overcome or counteract the inherent inflexibility characteristic of the relatively short hose structures per se and thereby in fact permit the plurality of applicator heads to be moved to different locations, depending upon the various different requirements attendant particular hot melt adhesive deposition requirements, in order to perform a particular hot melt adhesive deposition operation.

### FIELD OF THE INVENTION

The present invention relates generally to hot melt adhesive dispensing systems, and more particularly to a new and improved hot melt adhesive dispensing system wherein the hot melt adhesive dispensing system comprises a remote metering station for receiving a supply of hot melt adhesive material from an adhesive supply unit (ASU), a plurality of applicator heads for dispensing or depositing hot melt adhesive material onto different products or substrates, and a plurality of relatively short hose structures for respectively fluidically interconnecting the output ports of the remote metering station to the input ports of the plurality of applicator heads. In view of the fact that relatively short hose structures are inherently inflexible, the oppositely disposed terminal end portions of each one of the plurality of relatively short hose structures are respectively provided with universal connectors so as to in fact effectively overcome or counteract the inherent inflexibility characteristic of the relatively short hose structures per se that respectively fluidically interconnect the plurality of hot melt adhesive material output ports of the remote metering station to the plurality of input ports of the applicator heads, and thereby permit the plurality of applicator heads to be moved to various different positions or locations depending upon the various different requirements attendant particular hot melt adhesive material deposition operations.

### BACKGROUND OF THE INVENTION

In connection with liquid dispensing assemblies, and more particularly, in connection with liquid dispensing assemblies which are being used to dispense hot melt adhesives or other thermoplastic materials, a typical dispensing assembly conventionally comprises a supply source of the hot melt adhesive or thermoplastic material, and means for precisely or accurately metering and pumping the hot melt adhesive or thermoplastic material toward an applicator head or dispensing assembly. In connection with particular applications or procedures, it is necessary to accurately or precisely meter the hot melt adhesive or thermoplastic material being dispensed so as to ensure that a specific or predetermined volume of the hot melt adhesive or thermoplastic material is in fact dispensed within a specific or predetermined period of time. For example, in connection with the dispensing of hot melt adhesive materials, it is often necessary to provide a plurality of individual metering pumps for providing predetermined volumes of the hot melt adhesive material, which may in fact comprise similar or different volume quantities or amounts, to discrete, separate, or respective applicator heads or dispensing outlets. More particularly, it is desirable to have a gear pump assembly, for use in connection with a hot melt adhesive dispensing assembly, wherein the hot melt adhesive dispensing assembly comprises a plurality of rotary, gear-type pump assemblies mounted upon the hot melt adhesive dispensing assembly such that all of the rotary, gear-type pump assemblies are independent with respect to each other, wherein the plurality of rotary, gear-type pump assemblies are operatively driven by means of a common rotary drive shaft in such a manner that no external dynamic seals are required, wherein any particular one of the rotary, gear-type pump assemblies can be readily removable from the array or bank of rotary, gear-type pump assemblies independently of the other rotary, gear-type pump assemblies, and can be subsequently re-inserted into the array or bank of rotary, gear-type pump assemblies, or replaced by means of a new rotary, gear-type pump assembly, and wherein still further, as a result of the plurality of rotary, gear-type pump assemblies being independent with respect to each other and not being operatively driven by means of, or mounted upon, a common internally disposed rotary drive shaft, then should a particular one of the rotary, gear-type pump assemblies experience a failure, the failed rotary, gear-type pump assembly would not experience additional damage or cause the other rotary, gear-type pump assemblies to experience freezing or failure.

Such rotary, gear-type pump assemblies are disclosed within U.S. Pat. No. 6,688,498 which issued to McGuffey on Feb. 10, 2004, which patent is hereby incorporated herein by reference. While the aforenoted gear pump assemblies of McGuffey were disclosed within the aforenoted U.S. Pat. No. 6,688,498 as being utilized in an integral manner with a hot melt adhesive applicator head or dispensing assembly as a result of, for example, being mounted directly upon the applicator head or dispensing assembly, circumstances may arise when it is not possible or practical to utilize such rotary, gear-type pump assemblies in an integral manner with a hot melt adhesive applicator head or dispensing assembly. One possible instance may be, for example, wherein all of the applicator heads or dispensing nozzles are not disposed at one location. In this instance, the applicator heads or dispensing nozzles are to be fluidically connected to the aforenoted rotary, gear-type pump assemblies by means of suitable hose structures for conveying the hot melt adhesive material from the plurality of rotary, gear-type metering pumps to the applicator heads or dispensing nozzles.

However, it is undesirable that such hose structures have substantially large or elongated lengths in that predeterminedly desired pressure levels, and precisely metered or predetermined volumes of the hot melt adhesive material, are difficult to attain and maintain within such hose structures when the hose structures comprise substantial or significant length dimensions. It is therefore desirable to utilize a metering station which can effectively be located remotely from a source or supply of the hot melt adhesive material, and wherein further, the hot melt adhesive material remote metering station can then be respectively fluidically connected to the plurality of applicator heads or dispensing nozzles by means of relatively short hose structures. In this manner, predeterminedly desired pressure levels, and precisely metered or predetermined volumes of the hot melt adhesive material, can be achieved and maintained such that precisely metered or predetermined volumes of hot melt adhesive material can in fact be dispensed onto predetermined substrate locations. The use of relatively short hose structures, however, nevertheless results in the manifestation of additional problems. For example, it is often the case that the applicator heads need to be moved from one position to another depending upon the different products or substrates, and their inherent structural regions or locations, onto which the hot melt adhesive material is to be dispensed or deposited. Alternatively, the applicator heads may need to be moved from one position to another depending upon the size of the different products or substrates, or still yet further, the applicator heads may need to be moved from one position to another depending upon the particular pattern of hot melt adhesive material to be applied to the particular product or substrate. However, the problem that arises in connection with the use of such relatively short hoses is that they are inherently relatively inflexible, and therefore, the various applicator heads are not always able to be readily or easily moved to their desired positions or locations in order to in fact perform or achieve the desired dispensing or deposition of the hot melt adhesive material onto the particular regions of the particularly configured or particularly sized products or substrates.

A need therefore exists in the art for a new and improved hot melt adhesive dispensing system wherein, in connection with a remote metering station for receiving hot melt adhesive material from an adhesive supply unit (ASU), a plurality of applicator heads for dispensing or depositing hot melt adhesive material onto particular products or substrates in accordance with predetermined patterns, and a plurality of relatively short hoses for respectively fluidically interconnecting the hot melt adhesive material output ports of the remote metering station to the hot melt adhesive material input ports of the plurality of applicator heads, wherein means will be provided for effectively imparting flexibility to the aforenoted hose connections at both the plurality of output ports of the remote metering station and the plurality of input ports of the plurality of applicator heads so as to effectively overcome or counteract the inherent inflexibility characteristic of the relatively short hoses per se which respectively fluidically interconnect the hot melt adhesive material output ports of the remote metering station to the hot melt adhesive material input ports of the plurality of applicator heads.

### SUMMARY OF THE INVENTION

The foregoing and other objectives are achieved in accordance with the teachings and principles of the present invention through the provision of a new and improved hot melt adhesive material dispensing system which comprises a remote metering station for receiving a supply of hot melt adhesive material from an adhesive supply unit (ASU), a plurality of applicator heads for dispensing or depositing hot melt adhesive material onto different products or substrates, and a plurality of relatively short hose structures for respectively fluidically interconnecting the output ports of the remote metering station to the input ports of the plurality of applicator heads. In view of the fact that relatively short hose structures are inherently inflexible, the oppositely disposed terminal end portions of each one of the plurality of relatively short hose structures are respectively provided with universal connectors so as to in fact effectively overcome or counteract the inherent inflexibility characteristic of the relatively short hose structures per se that respectively fluidically interconnect the plurality of hot melt adhesive material output ports of the remote metering station to the plurality of input ports of the applicator heads, and thereby permit the plurality of applicator heads to be moved to various different positions or locations depending upon the various different requirements or parameters attendant particular hot melt adhesive material deposition operations.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a top plan view of a new and improved hot melt adhesive material dispensing system constructed in accordance with the principles and teachings of the present invention and showing the cooperative parts thereof; and

FIG. 2 is a side elevational view of the new and improved hot melt adhesive material dispensing system as disclosed within FIG. 1.

### DETAILED DESCRIPTION OF THE PREFERRED EMBODIMENT

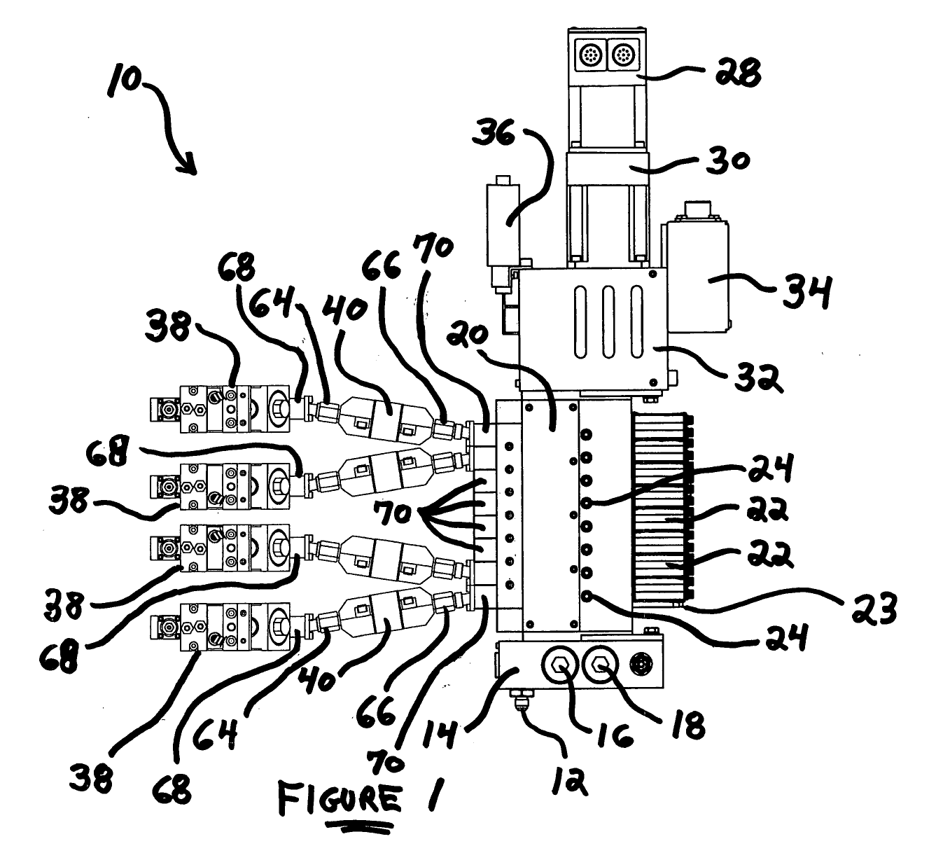

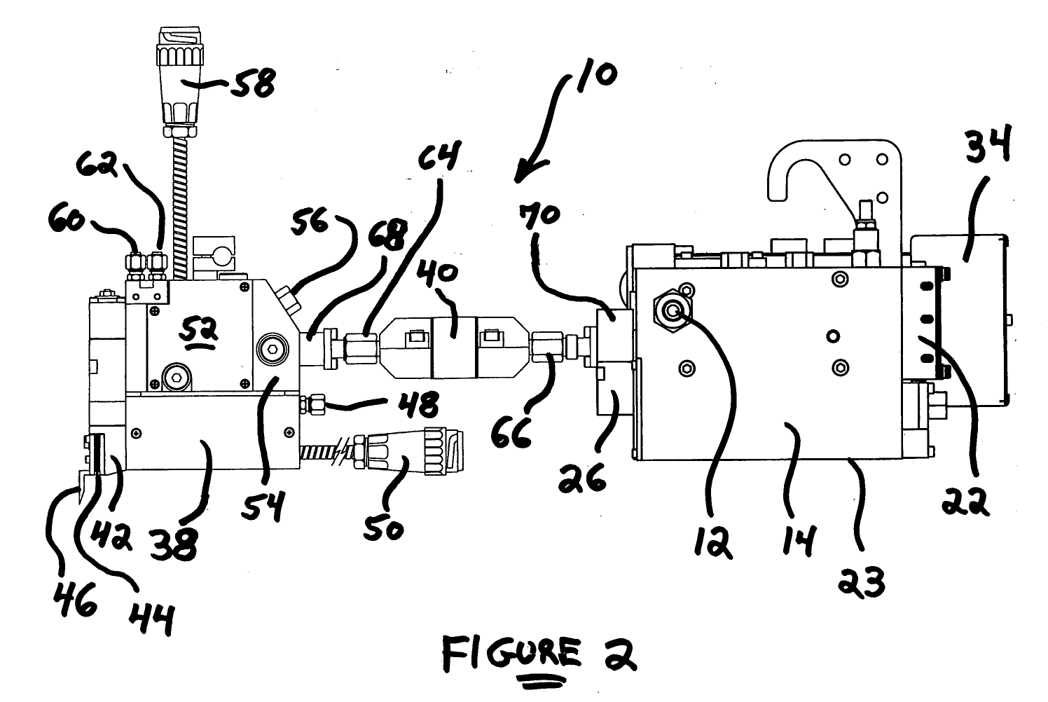

Referring now to the drawings, and more particularly to FIGS. 1 and 2 thereof, a new and improved hot melt adhesive material dispensing system, constructed in accordance with the principles and teachings of the present invention, is disclosed and is generally indicated by the reference character 10. More particularly, it is seen that the new and improved hot melt adhesive material dispensing system 10 comprises an inlet port 12 which is adapted to be fluidically connected, by means of a suitable supply hose, not illustrated, to a remotely located adhesive supply unit (ASU), also not illustrated, whereby a supply of hot melt adhesive material is able to be supplied to the hot melt adhesive material dispensing system 10. The inlet port 12 is mounted upon a filter block 14 within which there is disposed a pair of filter assemblies 16,18, and the filter block 14 is mounted upon a drive gear manifold 20 upon which a plurality of rotary, gear-type metering pump assemblies 22 are mounted so as to collectively effectively form or define a remote, hot melt adhesive material metering station 23. While any number of rotary, gear-type metering pump assemblies 22 may be mounted upon the drive gear manifold 20, eight rotary, gear-type metering pump assemblies 22 are illustrated, it being further appreciated that each one of the rotary, gear-type metering pump assemblies 22 effectively comprises a three-piece or three-plate sandwich construction within which the various gear members, comprising each one of the rotary, gear-type metering pump assemblies 22, are disposed. It is also seen that a plurality of pressure monitoring devices or mechanisms 24 are disposed atop the drive gear manifold 20, and that a plurality of hot melt adhesive material outlet port housings or transfer blocks 26, that is, eight outlet port housings or blocks, are adapted to be respectively fluidically connected to each one of the plurality of rotary, gear-type metering pump assemblies 22 through means of suitable fluid passageways, not illustrated, which are defined within the drive gear manifold 20. Still further, a drive motor 28 is adapted to be operatively connected, through means of a gear box 30 and a coupling 32, to a drive shaft, not illustrated, which is disposed within the drive gear manifold 20 and which is adapted to be operatively connected to each one of the plurality of rotary, gear-type metering pump assemblies 22, and it is also seen that an electrical junction box 34, for providing electrical power to the drive motor 28, and a pressure transducer 36 are operatively associated with the motor drive system.

Continuing further, it is also seen that a plurality of hot melt adhesive material applicator heads 38 are adapted to be respectively fluidically connected to selected ones of the hot melt adhesive material outlet port housings 26 by means of suitable hose connections 40, and that each one of the hot melt adhesive material applicator heads 38 is seen to comprise a module 42, a dispensing nozzle 44, and a strand guide 46. A first supply air coupling 48 is provided upon each one of the applicator heads 38 so as to respectively supply air into each applicator head 38 for mixture with the incoming hot melt adhesive material being supplied to each one of the applicator heads 38 from a respective one of the rotary, gear-type metering pump assemblies 22, and a first electrical connector for electrical connection to a supply air pre-heater mechanism, not illustrated, is disclosed at 50. Each applicator head 38 also comprises a hot melt adhesive material manifold 52, and a filter block 54, having a filter assembly 56 mounted thereon, is fixedly mounted upon the hot melt adhesive material manifold 52. In addition, a second electrical connector for electrical connection to a hot melt adhesive material pre-heater mechanism, not illustrated, is disclosed at 58, and second and third air couplings 60,62 are provided for conducting control air into the hot melt adhesive material manifold 52 in order to control the disposition of the hot melt adhesive material dispensing control valve mechanism, not illustrated, disposed within the hot melt adhesive material manifold 52 for controlling the dispensing of the hot melt adhesive material to the output or dispensing nozzle 44.

As can readily be appreciated from FIGS. 1 and 2, each one of the hose connections 40 respectively fluidically connecting a selected one of the rotary gear-type metering pump assemblies 22 of the hot melt adhesive material remote metering station to one of the applicator heads 38 is characterized by means of a relatively short or small length dimension, such as, for example, within the range of four inches (4.00″) to four feet (4.00″). It will be recalled that the hose connections or structures which fluidically interconnect the rotary gear-type metering pump assemblies 22 and the applicator heads 38 should preferably not have substantially large or elongated length dimensions in that predeterminedly desired pressure levels, and precisely metered or predetermined volumes, of the hot melt adhesive material, are difficult to attain and maintain within such hose structures or connections when the hose structures or connections comprise substantial or significant length dimensions. It is therefore desirable to utilize relatively short hose connections or structures such that predeterminedly desired pressure levels, and precisely metered or predetermined volumes of the hot melt adhesive material, can in fact be achieved and maintained whereby, in turn, precisely metered or predetermined volumes of hot melt adhesive material can in fact be dispensed onto predetermined substrate locations.

The use of relatively short hose structures or connections, however, nevertheless ordinarily results in the manifestation of additional problems. For example, it is often the case that the applicator heads 38 need to be moved from one position to another depending upon the different products or substrates, and the inherent structural regions or locations onto which the hot melt adhesive material is to be dispensed or deposited. Alternatively, the applicator heads 38 may need to be moved from one position to another depending upon the size or configuration of the different products or substrates, or still yet further, the applicator heads 38 may need to be moved from one position to another depending upon the particular pattern of hot melt adhesive material to be applied or deposited onto the specific product or substrate. However, the problem that arises in connection with the use of such relatively short hose structures or connections is that they are inherently relatively inflexible, and therefore, the various applicator heads 38 are not always able to be readily or easily moved to their desired positions or locations in order to in fact perform or achieve the desired dispensing or deposition of the hot melt adhesive material onto the particular regions of the particularly configured or particularly sized products or substrates, or in accordance with particularly desired or required hot melt adhesive material deposition patterns.

In accordance with the principles and teachings of the present invention, however, the aforenoted difficulties, normally heretofore encountered in connection with the use of such relatively short hose structures or connections, are advantageously resolved in view of the fact that, as can best be seen from FIGS. 1 and 2, the oppositely disposed terminal end portions 64,66 of each one of the hose structures or connections 40 are respectively provided with swivel connectors. More particularly, each one of the swivel connectors comprises a universal connector comprising, for example, a ball member disposed within a spherical socket or housing 68,70 wherein, for example, each one of the universal ball and socket housings 68 is fixedly attached to or mounted upon a respective one of the applicator heads 38 so as to also be fluidically connected thereto, while each one of the universal ball and socket housings 70 is fixedly attached to, mounted upon, or incorporated within each one of the hot melt adhesive material outlet port housings or transfer blocks 26 so as to likewise be fluidically connected thereto. Each one of the ball and socket housings or assemblies 68, 70 therefore permits the ball member thereof, fixedly mounted upon each oppositely disposed terminal end portion 64, 66 of each one of the hose structures or connections 40 to be movable within a field or range of movement comprising six degrees of freedom, as defined about or around three mutually orthogonal axes.

Accordingly, as can best be appreciated from FIG. 1, each one of the hose structures or connections 40 is able to be independently movable relative or with respect to its respective applicator head 38 as a result of the universal connection of its terminal end portion 64 to the applicator head 38 as permitted by means of the ball and socket housing assembly 68, while simultaneously therewith, each one of the hose structures or connections 40 is likewise able to be independently movable relative or with respect to the remote metering station 23 as a result of the universal connection of its terminal end portion 66 to the remote metering station 23 as permitted by means of the ball and socket housing assembly 70. It can therefore be appreciated still further that each one of the applicator heads 38 is able to be moved within the aforenoted field or range of movement, comprising the six degrees of freedom, with respect to the remote metering station 23, as a result of the compound movements of the hose structures or connections 40 as facilitated by means of the universal connectors 68,70. Considered from an alternative, but similar, point of view, the applicator heads 38 are effectively provided with a requisite amount of flexibility so as to be capable of being moved to various different positions or locations, as required or desired, depending upon the various different requirements or parameters attendant particular hot melt adhesive material deposition operations, so as to in fact achieve hot melt adhesive dispensing at various different product locations or in accordance with various different hot melt adhesive deposition patterns.

Thus, it may be seen that in accordance with the principles and teachings of the present invention, there has been provided a new and improved hot melt adhesive material dispensing system wherein the oppositely disposed terminal end portions of the plurality of relatively short hose structures or connections, for respectively fluidically interconnecting the output ports of the remote metering station to the input ports of the plurality of applicator heads, are provided with universal ball and socket housings, assemblies, or connectors so as to provide such relatively short hose structures or connections, which are normally inherently inflexible, with enhanced flexibility characteristics. Accordingly, the plurality of applicator heads are able to be moved to various different positions or locations depending upon the various different requirements or parameters attendant particular hot melt adhesive material deposition operations.

Obviously, many variations and modifications of the present invention are possible in light of the above teachings. It is therefore to be understood that within the scope of the appended claims, the present invention may be practiced otherwise than as specifically described herein.

What is claimed as new and desired to be protected by Letters Patent of the United States of America, is:

1. A liquid metering and dispensing system, comprising:
at least one metering pump assembly having an output port for outputting a metered amount of liquid;
at least one applicator head for dispensing liquid supplied thereto from said at least one metering pump assembly;
at least one hose member interposed between said at least one metering pump assembly output port and said at least one applicator head so as to define a fluidic hose connection between said at least one metering pump assembly output port and said at least one applicator head as a result of a first end portion of said at least one hose being connected to said at least one metering pump assembly output port while a second end portion of said at least one hose is connected to said at least one applicator head; and
at least one connector, exhibiting movements comprising multiple degrees of freedom, interconnecting at least one of said first and second end portions of said at least one hose member to one of said at least one metering pump assembly output port and said at least one applicator head so as to provide enhanced flexibility to said hose connection defined between said at least one metering pump assembly output port and said at least one applicator head whereby said at least one applicator head can readily achieve an enhanced range of movement.

2. The liquid metering and dispensing system as set forth in claim 1, wherein:
said at least one connector comprises a connector exhibiting movements comprising six degrees of freedom.

3. The liquid metering and dispensing system as set forth in claim 1, wherein:
said at least one connector comprises a connector exhibiting movements comprising six degrees of freedom as defined around three mutually orthogonal axes.

4. The liquid metering and dispensing system as set forth in claim 3, wherein:
said at least one connector, exhibiting movements comprising six degrees of freedom, comprises a universal connector.

5. The liquid metering and dispensing system as set forth in claim 4, wherein:
said universal connector comprises a ball and socket connector assembly.

6. The liquid metering and dispensing system as set forth in claim 1, wherein:
said at least one connector, interconnecting at least one of said first and second end portions of said at least one hose member to one of said at least one metering pump assembly output port and said at least one applicator head, comprises a pair of connectors interconnecting both said first end portion of said at least one hose member to said least one metering pump assembly output port and said second end portion of said at least one hose member to said at least one applicator head so as to provide enhanced flexibility to said hose connection defined between said at least one metering pump assembly output port and said at least one applicator head whereby said at least one applicator head can readily achieve an enhanced range of movement.

7. The liquid metering and dispensing system as set forth in claim 1, wherein:
said at least one hose member comprises a relatively short hose member having a length dimension which is within the range of four inches (4.00″) to four feet (4.00′).

8. The liquid metering and dispensing system as set forth in claim 1, wherein:
said at least one metering pump assembly comprises a plurality of metering pump assemblies defining a metering station;
said at least one applicator head comprises a plurality of applicator heads;
said at least one hose member comprises a plurality of hose members respectively interconnecting said plurality of applicator heads to said plurality of metering pump assemblies; and
said at least one connector, respectively interconnecting at least one of said first and second end portions of said at least one hose member to one of said at least one metering pump assembly output port and said at least one applicator head comprises a plurality of connectors for respectively interconnecting at least one said first and second end portions of said plurality of hose members to a respective one of said plurality of metering pump assembly output ports and to a respective one of said plurality of applicator heads so as to provide enhanced flexibility to each one of said hose connections defined between said plurality of metering pump assembly output ports and said plurality of applicator heads whereby each one of said plurality of applicator heads can readily achieve an enhanced range of movement.

9. A hot melt adhesive material metering and dispensing system, comprising:
at least one metering pump assembly having an output port for outputting a metered amount of hot melt adhesive material;
at least one applicator head for dispensing hot melt adhesive material supplied thereto from said at least one metering pump assembly;
at least one hose member interposed between said at least one metering pump assembly output port and said at least one applicator head so as to define a fluidic hose connection between said at least one metering pump assembly output port and said at least one applicator head as a result of a first end portion of said at least one hose being connected to said at least one metering pump assembly output port while a second end portion of said at least one hose is connected to said at least one applicator head; and
at least one connector, exhibiting movements comprising multiple degrees of freedom, interconnecting at least one of said first and second end portions of said at least one hose member to one of said at least one metering pump assembly output port and said at least one applicator head so as to provide enhanced flexibility to said hose connection defined between said at least one metering pump assembly output port and said at least one applicator head whereby said at least one applicator head can readily achieve an enhanced range of movement.

10. The hot melt adhesive material metering and dispensing system as set forth in claim 9, wherein:
said at least one connector comprises a connector exhibiting movements comprising six degrees of freedom.

11. The liquid metering and dispensing system as set forth in claim 9, wherein:
said at least one connector comprises a connector exhibiting movements comprising six degrees of freedom as defined around three mutually orthogonal axes.

12. The hot melt adhesive material metering and dispensing system as set forth in claim 11, wherein:
said at least one connector, exhibiting movements comprising six degrees of freedom, comprises a universal connector.

13. The hot melt adhesive material metering and dispensing system as set forth in claim 12, wherein:
said universal connector comprises a ball and socket connector assembly.

14. The hot melt adhesive material metering and dispensing system as set forth in claim 9, wherein:
said at least one connector, interconnecting at least one of said first and second end portions of said at least one hose member to one of said at least one metering pump assembly output port and said at least one applicator head, comprises a pair of connectors interconnecting both said first end portion of said at least one hose member to said least one metering pump assembly output port and said second end portion of said at least one hose member to said at least one applicator head so as to provide enhanced flexibility to said hose connection defined between said at least one metering pump assembly output port and said at least one applicator head whereby said at least one applicator head can readily achieve an enhanced range of movement.

15. The hot melt adhesive material metering and dispensing system as set forth in claim 9, wherein:
said at least one hose member comprises a relatively short hose member having a length dimension which is within the range of four inches (4.00″) to four feet (4.00′).

16. The hot melt adhesive material metering and dispensing system as set forth in claim 9, wherein:
said at least one metering pump assembly comprises a plurality of metering pump assemblies defining a remote hot melt adhesive material metering station;
said at least one applicator head comprises a plurality of applicator heads;
said at least one hose member comprises a plurality of hose members respectively interconnecting said plurality of applicator heads to said plurality of metering pump assemblies; and
said at least one connector, respectively interconnecting at least one of said first and second end portions of said at least one hose member to one of said at least one metering pump assembly output port and said at least one applicator head comprises a plurality of connectors for respectively interconnecting at least one said first and second end portions of said plurality of hose members to a respective one of said plurality of metering pump assembly output ports and to a respective one of said plurality of applicator heads so as to provide enhanced flexibility to each one of said hose connections defined between said plurality of metering pump assembly output ports and said plurality of applicator heads whereby each one of said plurality of applicator heads can readily achieve an enhanced range of movement.
